(19) United States
(12) Patent Application Publication
(10) Pub. No.: US 2024/0388835 A1
(43) Pub. Date: Nov. 21, 2024

(54) NOISE-REDUCING EARPLUG

(71) Applicant: Ping HU, Shenzhen City (CN)

(72) Inventor: Ping HU, Shenzhen City (CN)

(21) Appl. No.: 18/486,710

(22) Filed: Oct. 13, 2023

(30) Foreign Application Priority Data
May 15, 2023 (CN) 202321174217.5

(51) Int. Cl. H04R 1/10

(52) U.S. Cl. CPC H04R 1/1083; H04R 1/1008

(57) ABSTRACT

Disclosed is a noise-reducing earplug comprising a noise-reducing ring, an ear tip, and a central housing. The noise-reducing ring rotatably sleeves an outer side wall of the central housing, the noise-reducing ring is provided with an extension protrusion, the ear tip is mounted on an end of the extension protrusion away from the noise-reducing ring, a first sound channel is further provided in the extension protrusion, and the first sound channel is in communication with the end of the extension protrusion away from the noise-reducing ring and an inner side wall of the noise-reducing ring. The central housing is provided with a second sound channel which is in communication with the outer side wall of the central housing and an outer space of the central housing. The noise-reducing earplug provide different levels of noise reduction and achieves the switching between noise-reducing modes to improve the user experience.

### CROSS-REFERENCE TO RELATED APPLICATIONS

This application claims priority to Chinese Patent Application No. 202321174217.5, filed on May 15, 2023, the content of which is incorporated herein by reference in its entirety.

### TECHNICAL FIELD

The present application relates to the technical field of earplugs, and more particularly, to a noise-reducing earplug.

### BACKGROUND

The existing noise-reducing earplugs mainly rely on soft materials to directly isolate the ear canal from the outside air to achieve the noise-reducing effect, and in different environments, the user's demands for noise reduction are also different. For example, in buses and airplanes, a highly isolated noise-reducing effect is usually required; in the home or workplace, it is more comfortable reduce noise moderately. However, the existing noise-reducing earplugs only have a fixed noise-reducing mode, and cannot switch to a suitable noise-reducing mode according to the noise levels of different environments, thus affecting the user experience.

### SUMMARY

A technical problem to be solved by the present application is to provide a noise-reducing earplug that can switch between noise-reducing modes.

In order to solve the above-mentioned technical problem, the present application adopts the following technical solution: a noise-reducing earplug, comprising a noise-reducing ring, an ear tip, and a central housing, wherein the noise-reducing ring rotatably sleeves an outer side wall of the central housing, the noise-reducing ring is provided with an extension protrusion, the ear tip is mounted on an end of the extension protrusion away from the noise-reducing ring, a first sound channel is further provided in the extension protrusion, and the first sound channel is in communication with the end of the extension protrusion away from the noise-reducing ring and an inner side wall of the noise-reducing ring; and the central housing is provided with a second sound channel, and the second sound channel is in communication with the outer side wall of the central housing and an outer space of the central housing. Furthermore, there are a plurality of second sound channels, and openings of the second sound channels for communication with the outer space are of different diameters. Furthermore, a communication hole is provided in a central portion of the central housing, and the plurality of second sound channels are in communication with the communication hole.

Furthermore, a sound absorbing block is provided in the communication hole.

Furthermore, the sound absorbing block is made of sponge.

Further, the central housing is provided with a sound wave filtering screen, and the sound wave filtering screen covers the communication hole.

Furthermore, the noise-reducing ring is provided with an indication protrusion corresponding to a position of the first sound channel.

Furthermore, the central housing is provided with a limit protrusion that abuts against a bottom of the noise-reducing ring.

Furthermore, the limit protrusion is further provided with an identification layer, and the identification layer is blocked by the noise-reducing ring when the noise-reducing ring is completely mounted on the central housing.

Furthermore, a side wall of the central housing is provided with an expanding groove, and the second sound channel is in communication with the expanding groove.

The present application has the beneficial effects. The noise-reducing earplug provided by the present application is capable of switching between a plurality of noise-reducing modes. The noise-reducing ring is rotatably connected to the central housing, and the degree of communication between the first sound channel and the second sound channel can be adjusted by rotating the noise-reducing ring, so that the amount of external sound entering the ear tip can be controlled, so as to provide different levels of noise reduction; besides, the communication between the first sound channel and the second sound channel can be turned on and off by rotating the noise-reducing ring, thereby achieving the switching between noise-reducing modes and improving the user experience.

### BRIEF DESCRIPTION OF THE DRAWINGS

FIG. 1 is a schematic diagram showing the structure of a noise-reducing earplug of Embodiment I of the present application.

FIG. 2 is an exploded view of the noise-reducing earplug of Embodiment I of the present application.

FIG. 3 is a sectional view of the noise-reducing earplug of Embodiment I of the present application.

FIG. 4 is a sectional view of a noise-reducing earplug of Embodiment II of the present application.

### DETAILED DESCRIPTION OF THE EMBODIMENTS

In order to explain the technical contents, the achieved objects and the effects of the present application in detail, the following description is made in conjunction with the embodiments and the accompanying drawings.

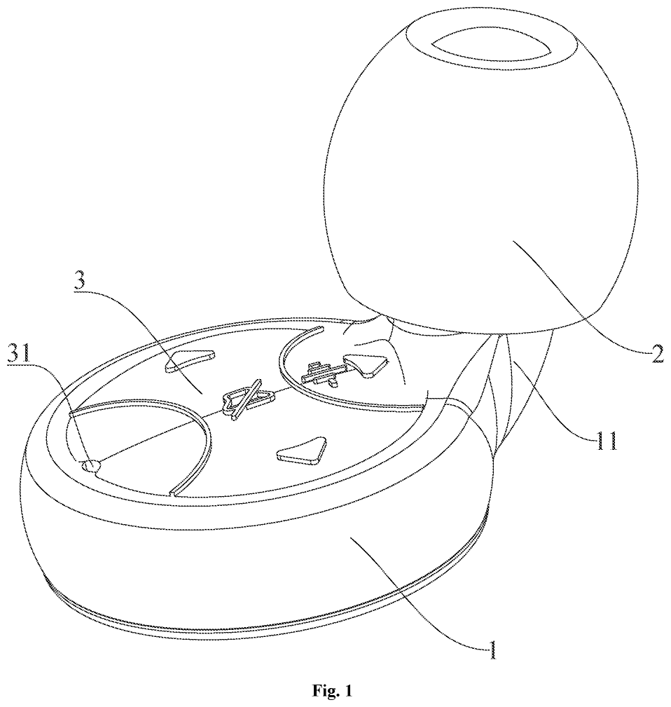

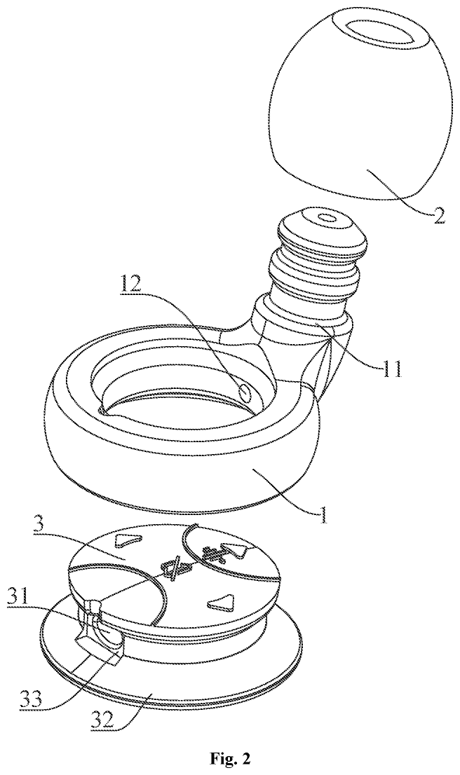

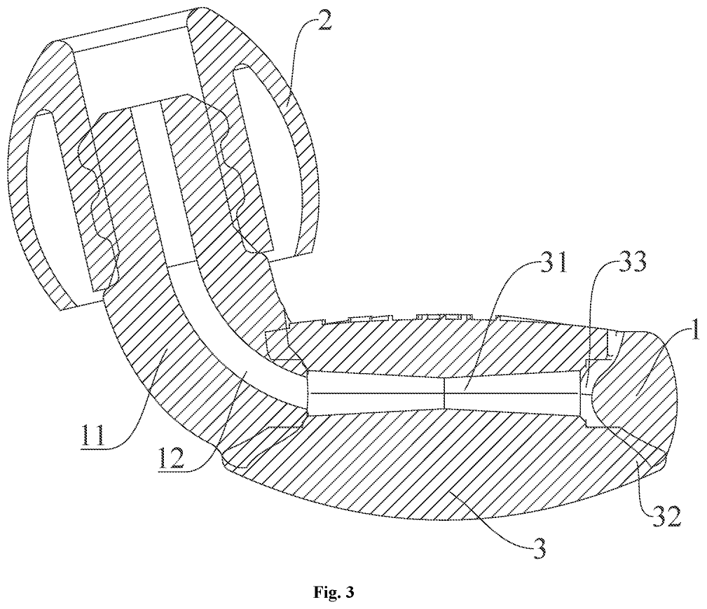

With reference to FIGS. 1 to 4, a noise-reducing earplug comprises a noise-reducing ring, an ear tip, and a central housing. The noise-reducing ring rotatably sleeves an outer side wall of the central housing, the noise-reducing ring is provided with an extending protrusion, the ear tip is mounted on an end of the extending protrusion away from the noise-reducing ring, a first sound channel is further provided in the extending protrusion, and the first sound channel is in communication with the end of the extending protrusion away from the noise-reducing ring and an inner side wall of the noise-reducing ring. The central housing is provided with a second sound channel, and the second sound channel is in communication with the outer side wall of the central housing and an outer space of the central housing. It can be seen from the above description that present application has the beneficial effects. The noise-reducing earplug provided by the present application is capable of switching between a plurality of noise-reducing modes. The noise-reducing ring is rotatably connected to the central housing, and the degree of communication between the first sound channel and the second sound channel can be adjusted by rotating the noise-reducing ring, so that the amount of external sound entering the ear tip can be controlled, so as to provide different levels of noise reduction; besides, the communication between the first sound channel and the second sound channel can be turned on and off by rotating the noise-reducing ring, thereby achieving the switching between noise-reducing modes and improving the user experience. Furthermore, there are a plurality of second sound channels, and openings of the second sound channels for communication with the outer space are of different diameters.

It can be seen from the above description that, with the plurality of second sound channels with openings of various diameters, the filtering of noise of different frequencies and intensities is enabled.

Furthermore, a communication hole is provided in a central portion of the central housing, and the plurality of second sound channels are in communication with the communication hole.

It can be seen from the above-mentioned description that, with the communication hole provided in the central portion of the central housing, the communication between the second sound channel and the outer space is facilitated.

Furthermore, a sound absorbing block is provided in the communication hole.

It can be seen from the above description that the sound absorbing block can further improve the effect of absorbing and filtering noise.

Furthermore, the sound absorbing block is made of sponge.

It can be seen from the above-mentioned description that the material of the sound absorbing block can be selected according to actual application requirements.

Furthermore, the central housing is provided with a sound wave filtering screen, and the sound wave filtering screen covers the communication hole.

It can be seen from the above description that, with the sound wave filtering screen of the central housing covering the communication hole, the filtering effect of sound waves transmitted into the communication hole can be improved.

Furthermore, the noise-reducing ring is provided with an indication protrusion corresponding to a position of the first sound channel.

It can be seen from the above-mentioned description that, the indication protrusion can indicate a user the position of the first sound channel, thereby providing convenience for the user to perform accurate adjustment.

Furthermore, the central housing is further provided with a limit protrusion that abuts against a bottom of the noise-reducing ring.

It can be seen from the above description that the limit protrusion can reduce the risk of the noise-reducing ring falling out of the central housing.

Furthermore, the limit protrusion is further provided with an identification layer, and the identification layer is blocked by the noise-reducing ring when the noise-reducing ring is completely mounted on the central housing.

It can be seen from the above-mentioned description that the identification layer can indicate a user whether the noise-reducing ring and the central housing are assembled in place.

Furthermore, a side wall of the central housing is provided with an expanding groove, and the second sound channel is in communication with the expanding groove.

It can be seen from the above description that the expanding groove can increase the permeable area of the second sound channel and improve the permeable effect.

### Embodiment I

With reference to FIGS. 1 to 3, Embodiment I of the present application provides a noise-reducing earplug, comprising a noise-reducing ring, an ear tip, and a central housing. The noise-reducing ring rotatably sleeves an outer side wall of the central housing, the noise-reducing ring is provided with an extension protrusion, the ear tip is mounted on an end of the extension protrusion away from the noise-reducing ring, a first sound channel is further provided in the extension protrusion, and the first sound channel is in communication with the end of the extension protrusion away from the noise-reducing ring and an inner side wall of the noise-reducing ring. The central housing is provided with a second sound channel, and the second sound channel is in communication with an outer side wall of the central housing and an outer space of the central housing. It would be readily understood that the noise-reducing ring is rotatably connected to the central housing, and the degree of communication between the first sound channel and the second sound channel can be adjusted by rotating the noise-reducing ring, so that the amount of external sound entering the ear tip can be controlled, so as to provide different levels of noise reduction; besides, the communication between the first sound channel and the second sound channel can be turned on and off by rotating the noise-reducing ring, thereby achieving the switching between noise-reducing modes and improving the user experience. Specifically, when the second sound channel is aligned with the first sound channel, the external sound may be transferred into the first sound channel via the second sound channel, and then transferred into the human ear via the first sound channel, so as to provide open noise reduction; otherwise, when the first sound channel and the second sound channel are not aligned, the external sound is conducted into the second sound channel via energy, but cannot be introduced into the human ear via the first sound channel as the second sound channel and the first sound channel are blocked from each other, so as to provide immersion noise reduction.

Preferably, the central housing is further provided with a limit protrusion which abuts against a bottom of the noise-reducing ring, and the limit protrusion can reduce the risk of the noise-reducing ring falling out of the central housing. Optionally, the limiting protrusion is further provided with an identification layer (not shown), and the identification layer is blocked by the noise-reducing ring when the noise-reducing ring is completely mounted on the central housing, so that the identification layer can indicate a user whether the noise-reducing ring and the central housing are assembled in place. Furthermore, optionally, the noise-reducing ring is provided with an indication protrusion corresponding to a position of the first sound channel, and the indication protrusion can indicate the user the position of the first sound channel, thereby providing convenience for the user to perform accurate adjustment.

In particular, a side wall of the central housing is provided with an expanding groove, and the second sound channel is in communication with the expanding groove. It can be understood that the expanding groove can increase the permeable area of the second sound channel and improve the permeable effect. In this embodiment, the second sound channel is in communication with two opposite side walls of the central housing.

### Embodiment II

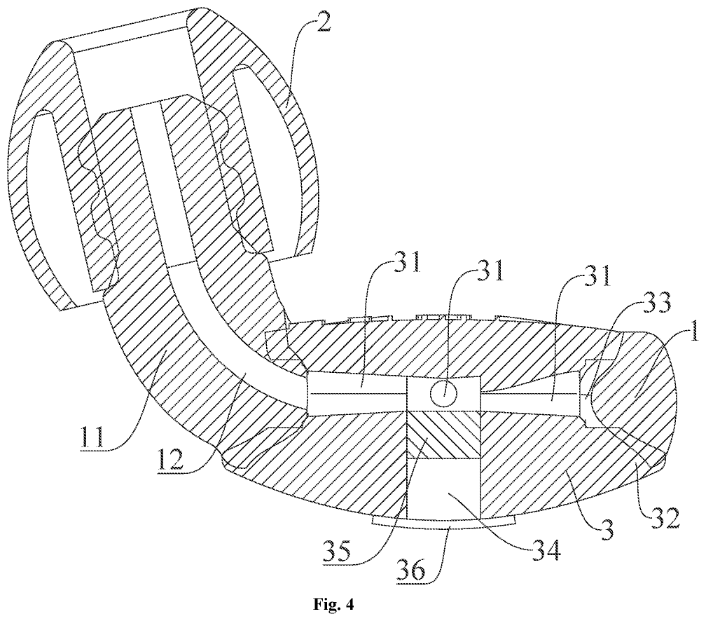

With reference to FIG. 4, Embodiment II of the present application further improves the central housing on the basis of the Embodiment I. Embodiment II differs from Embodiment I in that: there are a plurality of second sound channels, and openings of the second sound channels for communication with the outer space are of different diameters. With the plurality of second sound channels with openings of different diameters, the filtering of noise of different frequencies and intensities is enabled.

Preferably, a communication hole is provided in a central portion of the central housing, and the plurality of second sound channels are all in communication with the communication hole, thus facilitating the communication between the second sound channels and the outer space. Specifically, a sound absorbing block is provided in the communication hole, and the sound absorbing block can further improve the effect of absorbing and filtering noise. The sound absorbing block is made of sponge, and specifically, the material of the sound absorbing block can be selected according to practical application requirements. In particular the central housing is further provided with a sound wave filtering screen, and the sound wave filtering screen covers the communication hole. With the sound wave filtering screen of the central housing with covering the communication hole, the filtering effect of sound waves transmitted into the communication hole can be improved.

In summary, the noise-reducing earplug provided in the present application is capable of switching between multiple noise-reducing modes. The noise-reducing ring is rotatably connected to the central housing, and the degree of communication between the first sound channel and the second sound channel can be adjusted by rotating the noise-reducing ring, so that the amount of external sound entering the ear tip can be controlled, so as to provide different levels of noise reduction; besides, the communication between the first sound channel and the second sound channel can be turned on and off by rotating the noise-reducing ring, thereby achieving the switching between noise-reducing modes and improving the user experience.

The above-mentioned embodiments are merely examples of the present application, and are not therefore intended to limit the patent scope of the present application. Any equivalent transformation made by using the description and drawings of the present application, or direct or indirect application in the related technical field, is included within the scope of the patent protection of the present application.

What is claimed is:

1. A noise-reducing earplug, comprising a noise-reducing ring, an ear tip, and a central housing, wherein the noise-reducing ring rotatably sleeves an outer side wall of the central housing, the noise-reducing ring is provided with an extension protrusion, the ear tip is mounted on an end of the extension protrusion away from the noise-reducing ring, a first sound channel is further provided in the extension protrusion, and the first sound channel is in communication with the end of the extension protrusion away from the noise-reducing ring and an inner side wall of the noise-reducing ring; and the central housing is provided with a second sound channel, and the second sound channel is in communication with the outer side wall of the central housing and an outer space of the central housing.

2. The noise-reducing earplug of claim 1, wherein there are a plurality of second sound channels, and openings of the second sound channels for communication with the outer space are of different diameters.

3. The noise-reducing earplug of claim 2, wherein a communication hole is provided in a central portion of the central housing, and the plurality of second sound channels are in communication with the communication hole.

4. The noise-reducing earplug of claim 3, wherein a sound absorbing block is provided in the communication hole.

5. The noise-reducing earplug of claim 4, wherein the sound absorbing block is made of sponge.

6. The noise-reducing earplug of claim 3, wherein the central housing is further provided with a sound wave filtering screen, and the sound wave filtering screen covers the communication hole.

7. The noise-reducing earplug of claim 4, wherein the central housing is further provided with a sound wave filtering screen, and the sound wave filtering screen covers the communication hole.

8. The noise-reducing earplug of claim 1, wherein the noise-reducing ring is provided with an indicating protrusion corresponding to a position of the first sound channel.

9. The noise-reducing earplug of claim 1, wherein the central housing is further provided with a limit protrusion that abuts against a bottom of the noise-reducing ring.

10. The noise-reducing earplug of claim 8, wherein the limit protrusion is further provided with an identification layer, and the identification layer is blocked by the noise-reducing ring when the noise-reducing ring is completely mounted on the central housing.

11. The noise-reducing earplug of claim 1, wherein a side wall of the central housing is provided with an expanding groove, and the second sound channel is in communication with the expanding groove.
